(19) United States
(12) Patent Application Publication
(10) Pub. No.: US 2015/0178778 A1
(43) Pub. Date: Jun. 25, 2015

(54) LOCATION-BASED TRIGGERED DELIVERY SYSTEM

(71) Applicant: EBAY INC., San Jose, CA (US)

(72) Inventors: Jason Lee, San Ramon, CA (US); Ishan Shah, King of Prussia, PA (US); Xin Zhao, Bellevue, WA (US); Navid Samadani McQuirk, Menlo Park, CA (US); Skylur Robert Scott Jameson, Santa Clara, CA (US); Sandeep Chatra Raveesh, Sunnyvale, CA (US); Haresh Suresh, Austin, TX (US)

(73) Assignee: EBAY INC., SAN JOSE, CA (US)

(21) Appl. No.: 14/138,887

(22) Filed: Dec. 23, 2013

(51) Int. Cl. G06Q 30/02

(52) U.S. Cl. CPC G06Q 30/0261; G06Q 30/0264

(57) ABSTRACT

A system and method for a location-based triggered delivery are described. A location of a device of a user is determined. A condition for delivering an item at a delivery location is identified. The condition is trigged when the location of the device of the user crosses a geographic boundary for the device of the user. An estimated arrival time of the user to the delivery location is calculated. A courier available to deliver the item at the delivery location at the estimated arrival time is calculated. The courier is dispatched when the condition is triggered.

### TECHNICAL FIELD

This application relates generally to the field of computer technology and, in a specific example embodiment, to a method and system for a location-based triggered delivery.

### BACKGROUND

Online marketplaces allow sellers to list or publish information concerning items for sale. Once a buyer places an order for an item, the seller fulfills the order by shipping the item to the buyer.

The user will typically have to specify the destination address where the user would like the item to be shipped. The destination address may be, for example, a residence address or a business address of the user. However, the user may be required to be physically present at the destination address for items requiring a signature confirmation. When the user misses the delivery, the user typically would have to pick up the item at a another location, which causes much frustration and wasted time.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a location-based delivery application.

FIG. 4 shows a block diagram illustrating one example embodiment of a scheduler module.

FIG. 5 shows a block diagram illustrating one example embodiment of a triggered location-based delivery request module.

FIG. 6 shows a block diagram illustrating another example embodiment of a triggered location-based delivery request module.

FIG. 7 shows a flow diagram illustrating one example embodiment of an operation of the location-based delivery application.

FIG. 8 shows a flow diagram illustrating one example embodiment of an operation of a scheduler module.

FIG. 9 shows a flow diagram illustrating another example embodiment of an operation of a scheduler module.

FIG. 10 shows a ladder diagram illustrating one example embodiment of an operation of the location-based delivery application.

FIG. 11 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a location-based triggered delivery are described. A location of a device of a user is determined. A condition for delivering an item at a delivery location is identified. The user may be a buyer of the item from an online marketplace. The condition is trigged when the location of the device of the user crosses a geographic boundary for the device of the user. The geographic boundary for the device may be defined by the user. An estimated arrival time of the user to the delivery location is calculated. A courier available to deliver the item at the delivery location at the estimated arrival time is identified. The courier is dispatched when the condition is triggered.

In one example embodiment, the estimated arrival time of the user, and the delivery location, are communicated to a device of the courier. The estimated arrival time is based on the location of the device of the user when the condition is triggered, the delivery location, and traveling conditions of the user.

In one example embodiment, the courier is instructed to deliver the item at the delivery location within a time range of the estimated arrival time of the user.

In one example embodiment, the time range of the estimated arrival time of the user is adjusted based on a value of the item and a type of the item. The type of the item includes at least one of a perishable item and a non-perishable item.

In one example embodiment, an estimated travel time for each of a plurality of couriers is calculated based on a location of each courier and the delivery location. An estimated travel time for the user is calculated based on the geographic boundary of the device of the user and the delivery location. One or more couriers from the plurality of couriers having an estimated travel time for the corresponding courier less than the estimated travel time for the user are identified. The courier available to deliver the item at the delivery location at the estimated arrival time is selected from the identified one or more couriers.

In one example embodiment, a first estimated travel time is calculated for each of a plurality of couriers based on a location of each courier and a location of a seller or retailer having the item. A second estimated travel time for each of the plurality of couriers is calculated based on the location of the seller and the delivery location. A total estimated travel time for each of the plurality of couriers is calculated based on the sum of the corresponding first estimated travel time and the second estimated travel time. One or more couriers from the plurality of couriers having the total estimated travel time for the corresponding courier less than the estimated travel time for the user are identified. A courier available to deliver the item at the delivery location at the estimated arrival time is selected from the identified one or more couriers.

In one example embodiment, a pickup time at the seller is added to the total estimated travel time. The pickup time is based on a measure of in-store traffic at a store of the seller. A buffer time may be added to the total estimated travel time for each of the plurality of couriers. The buffer time may be based on corresponding traffic conditions for each of the plurality of couriers.

In one example embodiment, a location of the courier is monitored. The location of the courier is communicated to the device of the user after the condition is triggered. A geographic boundary for the courier may be defined based on the location of the courier and an estimated travel time for the user based on the geographic boundary of the device of the user and the delivery location. The courier may be alerted when the courier crosses the geographic boundary of the courier before the condition is triggered.

### System Architecture

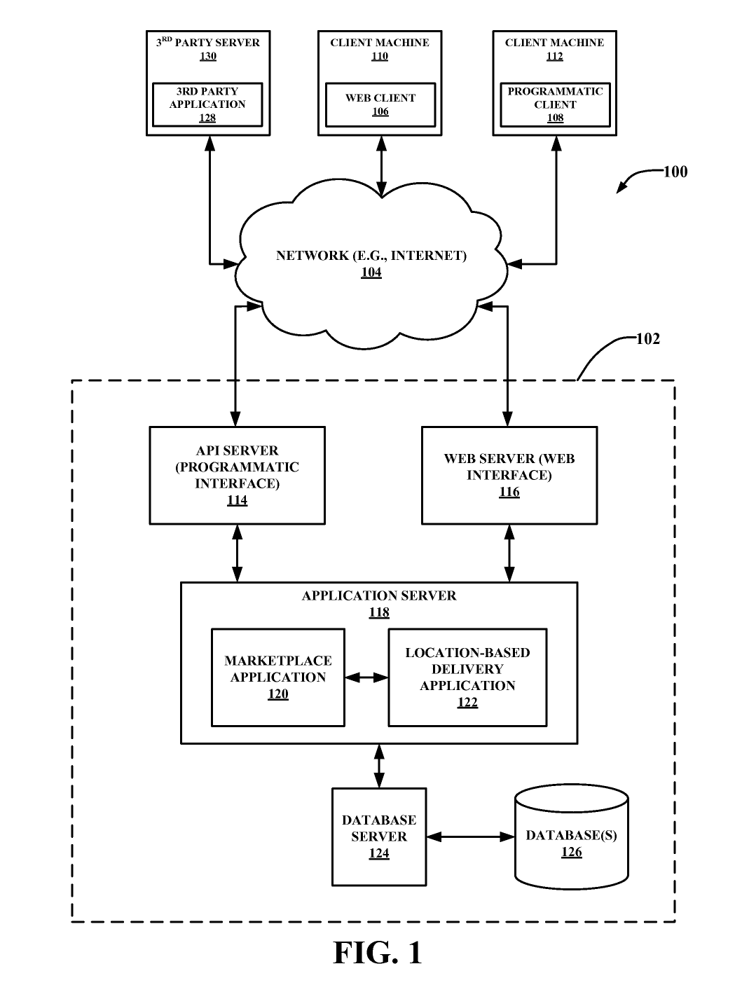

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a location-based delivery application 122, may provide server-side functionality via a network 104 (e.g., the Internet) to one or more clients. The one or more clients may include users that utilize the network system 100 and, more specifically, the marketplace application 120 andlocation-based delivery application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the location-based delivery application 122, an application program interface (API) server 114 and a web server 116 are coupled to, and provide programmatic and web interfaces respectively to, one or more application servers 118. The application server 118 hosts one or more marketplace applications 120 and a location-based delivery application 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120.

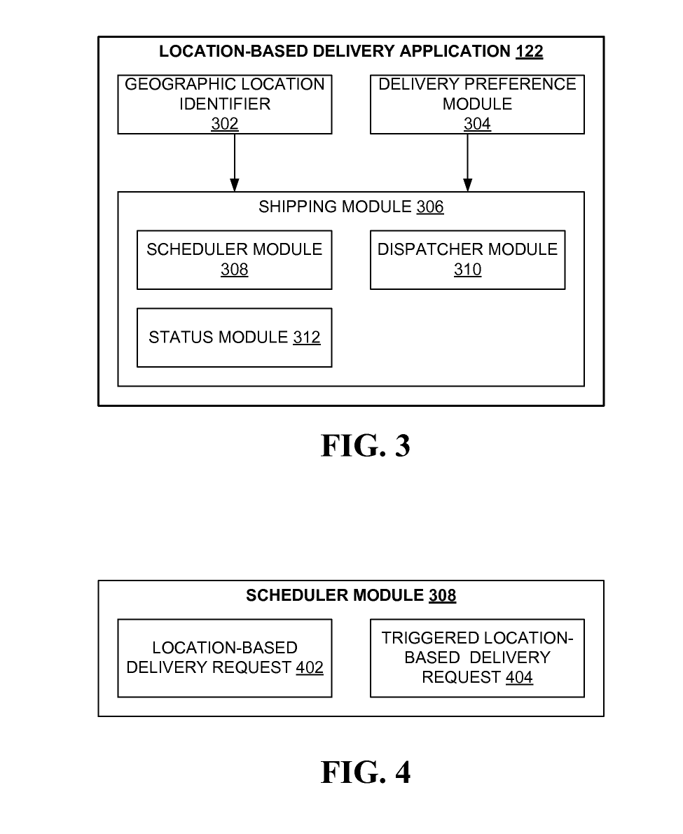

In one embodiment, the location-based delivery application 122 includes a system and a method for dispatching a courier to deliver the item based on a condition triggered by the location of a buyer of the marketplace application 120. For example, the buyer may set up a geographic boundary or a geofence based on the geographic location of a mobile device of the buyer. The buyer may request that the purchased item be delivered at about the same time the buyer arrives at a specified location (e.g., home). For example, the buyer may request the synchronized delivery at the buyer's home because the purchased items may be of high value or contain perishable food that may not be left at the front door of the buyer. Once the buyer crosses the geographic boundary, the location-based delivery application 122 may dispatch a courier to deliver the item purchased by the buyer at about the same time the buyer arrives at home, thereby catching the buyer in person and avoiding leaving the item at the front door. Components of the location-based delivery application 122 are described in more detail below with respect to FIG. 3.

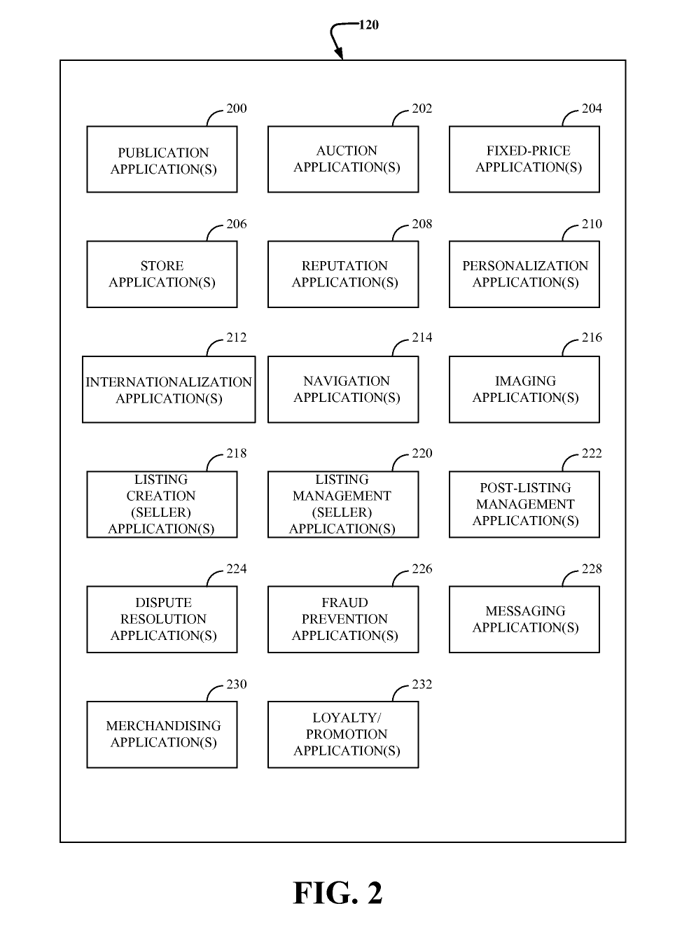

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the location-based delivery application 122 themselves are communicatively coupled (e.g., via appropriate interfaces) to each other and to various data sources, so as to allow information to be passed between the marketplace application 120 and the location-based delivery application 122 or so as to allow the marketplace application 120 and the location-based delivery application 122 to share and access common data. The marketplace application 120 and the location-based delivery application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the location-based delivery application 122. The location-based delivery application 122 may include a geographic location identifier 302, a delivery preference module 304, and a shipping module 306.

The geographic location identifier 302 identifies a geographic location of the mobile device of a buyer in the marketplace application 120. The buyer may include a user who views an item for sale using the marketplace application 120. The term “buyer” may also refer to a user who has purchased or not yet purchased the item in the marketplace application 120. For example, the user may be referred to as a buyer when the user views items for sale without placing a purchase order, places any item for sale in a virtual shopping cart or wish list, or submits an order for any item for sale. In one embodiment, the geographic location identifier 302 may determine the geographic location of the mobile device based on GPS data, WiFi data, and other data received from the mobile device.

The delivery preference module 304 identifies a delivery preference set by the buyer. Examples of delivery preferences may include an “I want it now” preference and an “I want it when I get home” preference.

In the “I want it now” preference, the location-based delivery application 122 tracks the location of the buyer based on the geographic location of the mobile device of the buyer, and dispatches a carrier to retrieve and deliver the item at a dynamic location of the buyer. For example, the buyer may order the item from home in the morning. At the time of the order, a courier is dispatched to retrieve the item from the seller. The courier then locates the buyer and delivers the item at the location of the buyer. For example, the buyer may be at his office for the rest of the day after placing the order in the morning. The courier tracks the location of the buyer and delivers the item at the buyer's office.

In the “I want it when I get home” feature, the location-based delivery application 122 tracks the location of the buyer based on the geographic location of the mobile device of the buyer, detects that the buyer has crossed a geographic boundary (e.g. office or school campus). A carrier is then dispatched to sync up with the travel time of the buyer to his home so that the item can be delivered at about the same time. In another example embodiment, the buyer may already be on his way home when he orders the item. As such, a carrier may be dispatched when the order is placed irrespective of the geographic boundary set by the buyer.

In another embodiment, the delivery preference module 304 may include other shipping or delivery preferences such as leaving the item without signatures, or leaving the item in a particular location, special handling for certain types of items (e.g. items valued at more than $100, perishable food items, or regulated items such as guns, alcohol, or drugs).

The shipping module 306 may be configured to generate shipping or delivery instructions based on the geographic location of the buyer and the delivery preference of the buyer. In one example embodiment, the shipping module 306 may include a scheduler module 308, a dispatcher module 310, and a status module 312.

The scheduler module 308 may determine when to schedule delivery or dispatch a courier to pick up and deliver an item to the buyer or to a location specified by the buyer. An example embodiment of the scheduler module 308 is illustrated in FIG. 4 and includes a location-based delivery request module 402 and a triggered location-based delivery request module 404.

The location-based delivery request module 402 may be used to implement the “I want it now” preference from the delivery preference module 304. For example, the location-based delivery request module 402 may dynamically determine and track the location of the buyer so that the courier can follow and deliver the item to the buyer. As such, the delivery location can be dynamic or static based on the movement of the buyer.

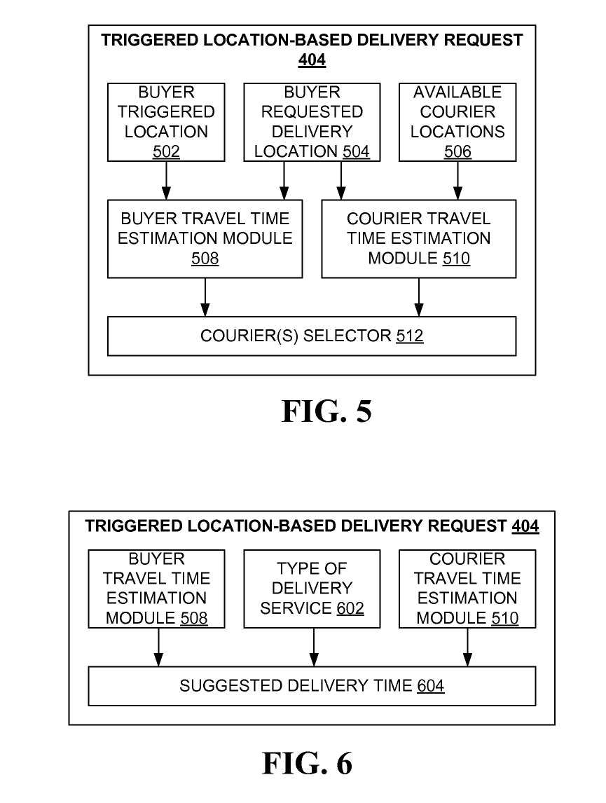

The triggered location-based delivery request module 404 may be used to implement the “I want it when I get home” preference from the delivery preference module 304. For example, the triggered location-based delivery request module 404 may dynamically determine and track the location of the buyer so that the courier can deliver the item at a buyer-specified location (e.g., home, office, etc.). Example components of the triggered location-based delivery request module 404 are described in more detail in FIGS. 5 and 6.

FIG. 5 shows a block diagram illustrating one example embodiment of the triggered location-based delivery request module 404. The triggered location-based delivery request module 404 may include a buyer-triggered location module 502, a buyer requested delivery location module 504, an available courier location module 506, a buyer travel time estimation module 508, a courier travel time estimation module 510, and a courier selector 512.

The buyer-triggered location module 502 may detect whether the buyer has cross a predefined geographic boundary set by the buyer. For example, the buyer may have set his/her current geographic location (e.g., present location at a coffee shop, office, etc.) as the boundary such that when the buyer leaves the current geographic location, a condition for dispatching the carrier is triggered. In one example embodiment, the current geographic location may include the location at the time the buyer has placed an order for the item on the marketplace application 120. In another example embodiment, the predefined geographic boundary may include a location specified by the buyer, such as a campus, a neighbourhood, or a mall. For example, when the buyer leaves the mall, the condition for dispatching the carrier is triggered. In another example embodiment, the predefined geographic boundary may include a location where the buyer is currently present or another physical location distant from the current location of the buyer. In another example embodiment, the buyer may have already left his office and placed an order while on the road. As such, a courier is dispatched upon receipt of the order regardless of any predefined geographic boundary of the buyer. In that case, the dispatch is triggered upon receipt of the order.

The buyer requested delivery location module 504 may identify the location where the buyer wishes the item to be delivered. For example, the location may be a home address or any other address specified by the buyer where the buyer would like to be physically present for the delivery of the item. The delivery location may include a static geographic location (e.g., home address).

The available courier location module 506 may identify which couriers are available to deliver item at the delivery location based on the availability of the courier and the location of the courier. For example, available couriers may be identified based on their schedule, availability status, and geographic region using data from the mobile devices of the couriers. The available courier location module 506 may identify and track the geographic location of the couriers. Couriers that are available and within a predefined radius, region, or zone may be identified for picking up and/or delivering the item to the buyer's preset delivery location. In another example embodiment, the available courier location module 506 selects one or more available courier based on their availability, distance, and feedback ratings.

The buyer travel time estimation module 508 calculates an estimated time of travel based on the type of transportation of the buyer (e.g., metro, bus, car, bike) between the triggered location of the buyer and the delivery location. The triggered location may include the location where the buyer crosses the geographic boundary. For example, the geographic boundary may include a school campus. The buyer leaves the school campus through the south gate of the school campus. In that case, the triggered location is the location of the south gate of the school campus. In another example, the triggered location may be the office address of the buyer so that when the buyer leaves his office, the condition is triggered.

The buyer may identify and communicate the type of transportation to the location-based delivery application 122. In another embodiment, the type of transportation used by the buyer may be determined by the location-based delivery application 122 by using the speed and route used by the buyer. The buyer estimated travel time may factor in travel conditions (e.g., accidents, traffic, construction, delay, weather) based on the type of transportation of the buyer. The buyer travel time estimation module 508 may then use the buyer estimated travel time to estimate the arrival time of the buyer at the delivery location.

The courier travel time estimation module 510 calculates an estimated time of travel for one or more available couriers between their respective current location and the delivery location set by the buyer. The estimated time of travel may be based on the type of transportation used by the corresponding courier (e.g., bike, car, motorbike), the distance between a current location of the courier and the delivery location, the route between a current location of the courier and the delivery location, and traffic conditions. The current location may include a geographic location of the courier at the time the condition is triggered.

In another embodiment, the courier travel time estimation module 510 calculates an estimated time of travel for one or more available couriers between their respective current location, a seller of the item, and the delivery location set by the buyer. For example, the courier may have to pick up the item from a retail store and deliver the item to the delivery location of the buyer. As such, the estimated travel time of a courier may include travel time from a current location of the courier to the retail store, pick up time at the retail store, and travel time from the retail store to the delivery location of the buyer.

The courier selector 512 identifies one or more couriers with a corresponding estimated travel time less than the estimated buyer travel time. In one example embodiment, the courier selector 512 selects a courier with a lowest estimated travel time. In another example embodiment, the courier selector 512 may also select a courier based on a feedback rating of the courier. The feedback rating may be based on previous customer ratings of the courier.

FIG. 6 shows a block diagram illustrating another example embodiment of the triggered location-based delivery request module 404. The triggered location-based delivery request module 404 may include the buyer travel time estimation module 508, a type of delivery service 602, the courier travel time estimation module 510, and a suggested delivery time module 604.

The type of delivery service 602 may be based on a value of the item and whether the item is perishable. The type of delivery service 602 may include whether the item has to be delivered in person to the buyer, whether the item may be left unattended at the delivery location, whether the item is to be delivered after the buyer arrives at the delivery location, whether the item is to be delivered before the buyer arrives at the delivery location, and a maximum amount of time or a range of time that the item can be delivered before or after the buyer arrives at the delivery location.

The suggested delivery time module 604 may compute a suggested delivery time based on the estimated travel time of the buyer, the estimated travel time of the courier, and the type of delivery service. For example, at 2 pm, the estimated travel time of the buyer is 30 minutes, the estimated travel of the courier is 20 minutes, and the type of delivery service is hand delivered to the buyer because the value of the item exceeds $100. The suggested delivery time module 604 may suggest a delivery time of 2:30 pm to the courier. If the type of delivery service is a 5 minute time range, then the suggested delivery time module 604 may suggest a delivery time range (e.g., 2:25 pm to 2:35 pm). If the type of delivery service is to leave the item unattended, the suggested delivery time may be 2:20 pm.

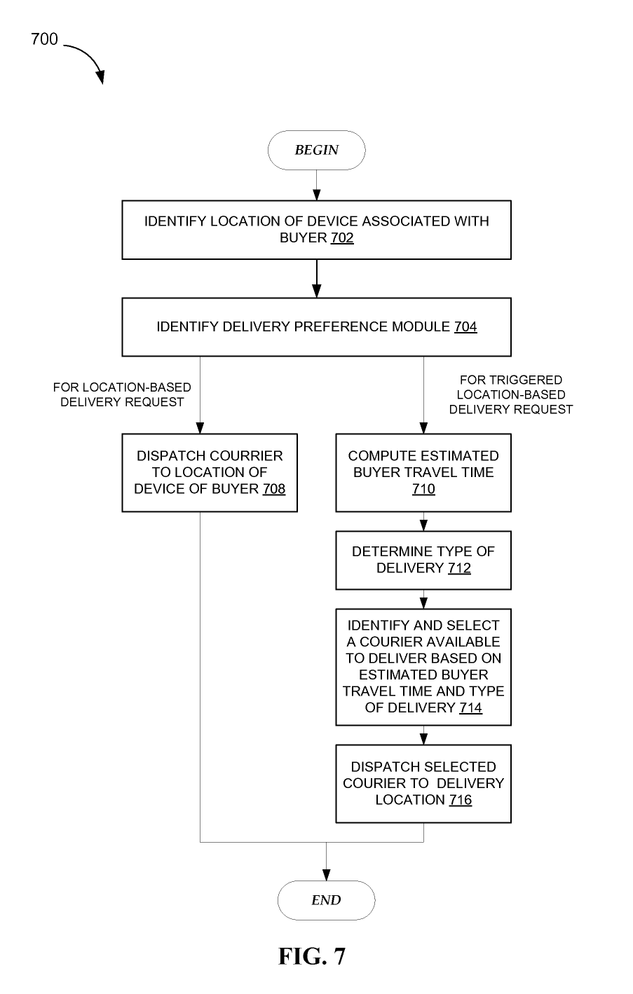

FIG. 7 shows a flow diagram illustrating one example embodiment of an operation of the location-based delivery application 122. At 702, the location of a device associated with a buyer of the marketplace application 120 is identified using GPS data, WiFi data, or triangulation data from the mobile device.

At 704, the delivery preference of the buyer is identified. For example, the delivery preference may specify that the buyer wants the item delivered at a dynamic location of the buyer. This preference may be referred to as a location-based delivery preference. The delivery preference may also include that the buyer wants to have the item delivered when the buyer arrives home. This preference may be referred to as a triggered location-based delivery request.

At 708, for location-based delivery requests, a courier is dispatched to the location of the device of the buyer. In one example embodiment, the courier may first be dispatched to pick up the item from a seller of the item or a retail store and then deliver the item to the dynamic location of the device of the buyer.

At 710, for triggered location-based delivery requests, an estimated travel time of the buyer to the delivery location is calculated.

At 712, the type of delivery is determined.

At 714, an available courier is identified and selected to deliver the item based on the estimated travel time of the courier to the delivery location, the estimated travel time of the buyer to the delivery location, and a type of delivery. In one example embodiment, the available courier is also identified based on the estimated travel time of the courier to the retailer having the item in stock and the estimated travel time from the retailer to the delivery location.

At 716, the selected courier is dispatched to the delivery location.

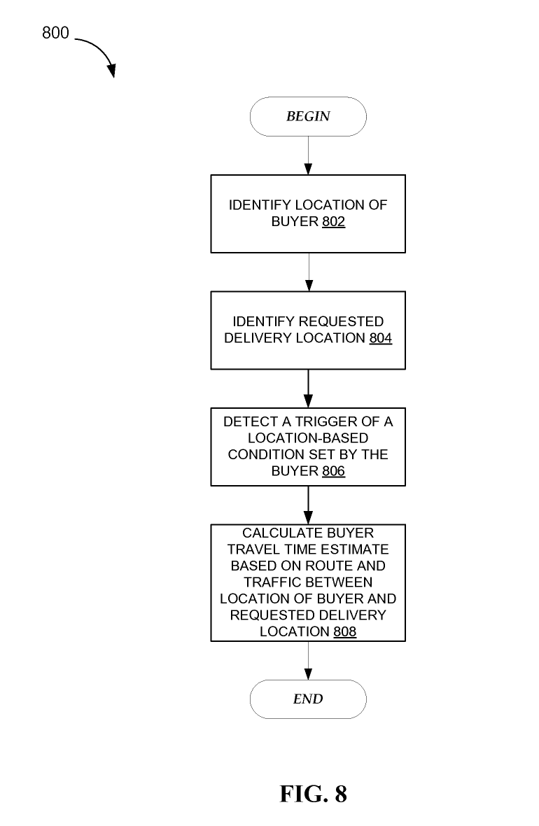

FIG. 8 shows a flow diagram illustrating one example embodiment of an operation 800 of a scheduler module. At 802, the location of the buyer is identified. At 804, the requested delivery location is identified. At 806, a trigger of a location-based condition set by the buyer is detected. At 808, the buyer travel time estimate is calculated based on the route and traffic between the location of the buyer and the requested delivery location.

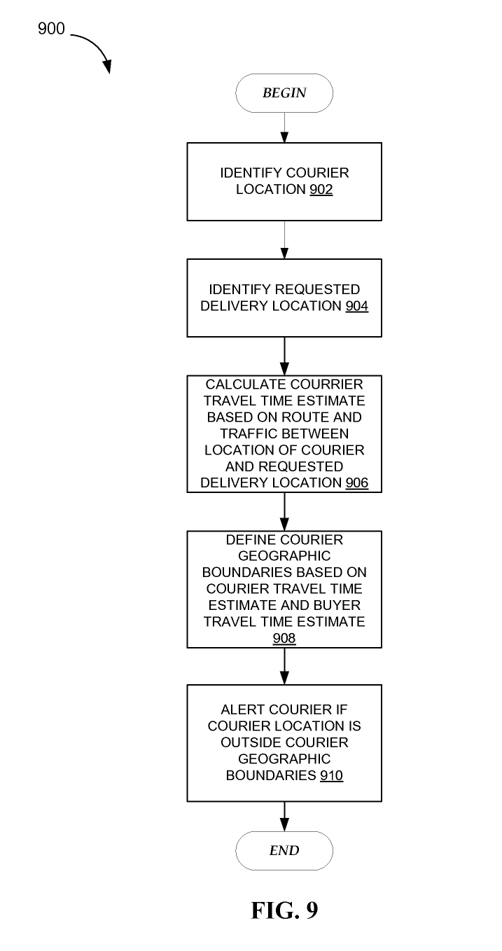

FIG. 9 shows a flow diagram illustrating another example embodiment of an operation 900 of the scheduler module 308. At 902, the location of the courier is identified. At 904, the requested delivery location is identified. At 906, the courier travel time estimate is calculated based on the route and traffic between the location of the courier and the requested delivery location. At 908, the courier geographic boundaries based on the courier travel time estimate and the buyer travel time estimate are defined. At 910, if the courier location is outside the geographic boundaries, the courier is alerted. For example, the courier cannot venture too far out to a point where the travel time to the delivery location exceeds the travel time of the buyer from the triggered location to the delivery location.

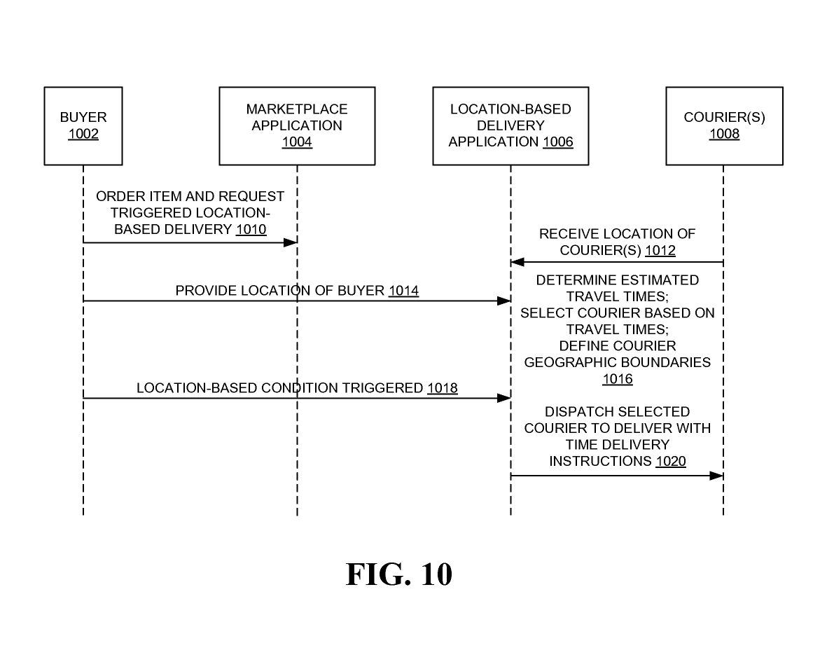

FIG. 10 shows a ladder diagram illustrating one example embodiment of an operation of the location-based delivery application. The buyer 1002 places an order for an item with the marketplace application 1004 and requests a triggered location-based delivery at 1010. The buyer 1002 provides a current location of a mobile device associated with the buyer at 1014 to the location-based delivery application 1006. At 1012, couriers 1008 provide their corresponding locations to the location-based delivery application 1006. At 1016, the location-based delivery application 1006 determines estimated travel times of the buyer and the couriers, and selects a courier with corresponding courier travel time less than buyer travel time. At 1016, the location-based delivery application 1006 also defines courier geographic boundaries. At 1018, the location-based delivery application 1006 detects that the location of the buyer triggers a location-based condition. At 1020, the location-based delivery application 1006 dispatches the selected courier to deliver the item with time delivery instructions.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

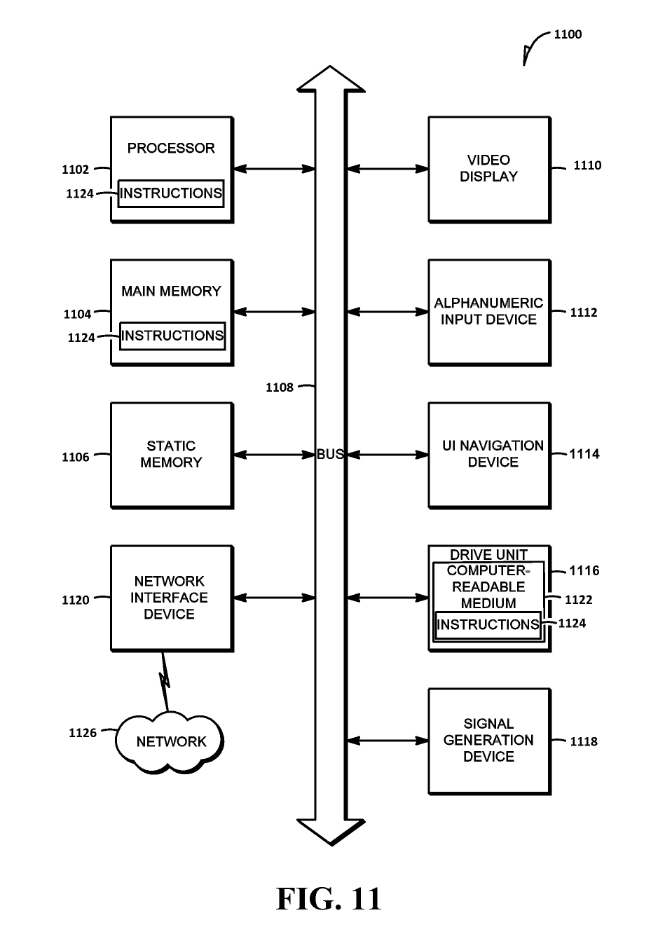

FIG. 11 shows a diagrammatic representation of a machine in the example form of a computer system 1100 within which a set of instructions 1124 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1124 (sequential or otherwise) that specify actions to be taken by that machine. Further, while only a single machine is illustrated, the term “machine” shall also be taken to include any collection of machines that individually or jointly execute a set (or multiple sets) of instructions 1124 to perform any one or more of the methodologies discussed herein.

The example computer system 1100 includes a processor 1102 (e.g., a central processing unit (CPU), a graphics processing unit (GPU), or both)), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a UI navigation device 1114 (e.g., a mouse), a disk drive unit 1116, a signal generation device 1118 (e.g., a speaker), and a network interface device 1120.

The disk drive unit 1116 includes a computer-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media.

The instructions 1124 may further be transmitted or received over a network 1126 via the network interface device 1120 utilizing any one of a number of well-known transfer protocols (e.g., HTTP).

While the computer-readable medium 1122 is shown in an example embodiment to be a single medium, the term “computer-readable medium” should be taken to include a single medium or multiple media (e.g., a centralized or distributed database, and/or associated caches and servers) that store the one or more sets of instructions 1124. The term “computer-readable medium” shall also be taken to include any medium that is capable of storing, encoding, or carrying a set of instructions 1124 for execution by the machine and that cause the machine to perform any one or more of the methodologies of the present disclosure, or that is capable of storing, encoding or carrying data structures utilized by or associated with such a set of instructions 1124. The term “computer-readable medium” shall, accordingly, be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a geographic location detector executable by a processor configured to determine a location of a device of a user;
a delivery preference module configured to identify a condition for delivering an item at a delivery location, the condition comprising a geographic boundary for the device of the user;
a scheduler module configured to detect that the condition is trigged when the location of the device of the user crosses the geographic boundary of the device of the user, to calculate an estimated arrival time of the user to the delivery location, to identify a courier available to deliver the item at the delivery location at the estimated arrival time; and
a dispatcher module configured to dispatch the courier when the condition is triggered.

2. The system of claim 1, wherein the user is a buyer of the item from an online marketplace, wherein the geographic boundary of the device is defined by the user.

3. The system of claim 1, wherein the estimated arrival time is based on the location of the device of the user when the condition is triggered, the delivery location, and traveling conditions of the user,
wherein the scheduler module is configured to communicate the estimated arrival time of the user and the delivery location to a device of the courier.

4. The system of claim 3, wherein the scheduler module is configured to instruct the courier to deliver the item at the delivery location within a time range of the estimated arrival time of the user.

5. The system of claim 4, wherein the time range of the estimated arrival time of the user is adjusted based on a value of the item and a type of the item, the type of the item including at least one of a perishable item and a non-perishable item.

6. The system of claim 1, wherein the scheduler module is configured to:
calculate an estimated travel time for each of a plurality of couriers based on a location of each courier and the delivery location,
calculate an estimated travel time for the user based on the geographic boundary of the device of the user and the delivery location,
identify one or more couriers from the plurality of couriers having an estimated travel time for the corresponding courier less than the estimated travel time for the user; and
select from the identified one or more couriers, the courier available to deliver the item at the delivery location at the estimated arrival time.

7. The system of claim 1, wherein the scheduler module is configured to:
calculate a first estimated travel time for each of a plurality of couriers based on a location of each courier and a location of a seller having the item,
calculate a second estimated travel time for each of the plurality of couriers based on the location of the seller and the delivery location,
calculate a total estimated travel time for each of the plurality of couriers based on the sum of the corresponding first estimated travel time and the second estimated travel time,
identify one or more couriers from the plurality of couriers having the total estimated travel time for the corresponding courier less than the estimated travel time for the user,
select the courier available to deliver the item at the delivery location at the estimated arrival time from the identified one or more couriers.

8. The system of claim 7, wherein the scheduler module is configured to:
add a pickup time at the seller to the total estimated travel time, the pickup time based on a measure of in-store traffic at the seller.

9. The system of claim 7, wherein the scheduler module is configured to:
add a buffer time to the total estimated travel time for each of the plurality of couriers, the buffer time based on corresponding traffic conditions for each of the plurality of couriers.

10. The system of claim 1, further comprising a status module configured to: monitor a location of the courier,
communicate the location of the courier to the device of the user after the condition is triggered,
define a geographic boundary of the courier based on the location of the courier and an estimated travel time for the user based on the geographic boundary of the device of the user and the delivery location; and
alert the courier when the courier crosses the geographic boundary of the courier before the condition is triggered.

11. A method comprising:
determining a location of a device of a user;
identifying a condition for delivering an item at a delivery location, the condition comprising a geographic boundary for the device of the user;
detecting that the condition is trigged when the location of the device of the user crosses the geographic boundary of the device of the user;
calculating an estimated arrival time of the user to the delivery location;
identifying a courier available to deliver the item at the delivery location at the estimated arrival time; and
dispatching the courier when the condition is triggered.

12. The method of claim 11, wherein the user is a buyer of the item from an online marketplace, wherein the geographic boundary of the device is defined by the user.

13. The method of claim 11, further comprising:
communicating the estimated arrival time of the user and the delivery location to a device of the courier, wherein the estimated arrival time is based on the location of the device of the user when the condition is triggered, the delivery location, and traveling conditions of the user.

14. The method of claim 13, further comprising:
instructing the courier to deliver the item at the delivery location within a time range of the estimated arrival time of the user.

15. The method of claim 14, further comprising:
adjusting the time range of the estimated arrival time of the user based on a value of the item and a type of the item, the type of the item including at least one of a perishable item and a non-perishable item.

16. The method of claim 11, further comprising:
calculating an estimated travel time for each of a plurality of couriers based on a location of each courier and the delivery location;
calculating an estimated travel time for the user based on the geographic boundary of the device of the user and the delivery location;
identifying one or more couriers from the plurality of couriers having an estimated travel time for the corresponding courier less than the estimated travel time for the user; and
selecting from the identified one or more couriers, the courier available to deliver the item at the delivery location at the estimated arrival time.

17. The method of claim 11, further comprising:
calculating a first estimated travel time for each of a plurality of couriers based on a location of each courier and a location of a seller having the item,
calculating a second estimated travel time for each of the plurality of couriers based on the location of the seller and the delivery location,
calculating a total estimated travel time for each of the plurality of couriers based on the sum of the corresponding first estimated travel time and the second estimated travel time,
identifying one or more couriers from the plurality of couriers having the total estimated travel time for the corresponding courier less than the estimated travel time for the user; and
selecting from the identified one or more couriers, the courier available to deliver the item at the delivery location at the estimated arrival time.

18. The method of claim 17, further comprising:
adding a pickup time at the seller to the total estimated travel time, the pickup time based on a measure of in-store traffic at the seller; and
adding a buffer time to the total estimated travel time for each of the plurality of couriers, the buffer time based on corresponding traffic conditions for each of the plurality of couriers.

19. The method of claim 11, further comprising:
monitoring a location of the courier;
communicating the location of the courier to the device of the user after the condition is triggered;
defining a geographic boundary of the courier based on the location of the courier and an estimated travel time for the user based on the geographic boundary of the device of the user and the delivery location; and
alerting the courier when the courier crosses the geographic boundary of the courier before the condition is triggered.

20. A non-transitory computer-readable storage medium storing a set of instructions that, when executed by a processor, cause the processor to perform operations, comprising:
determining a location of a device of a user;
identifying a condition for delivering an item at a delivery location, the condition comprising a geographic boundary for the device of the user;
detecting that the condition is trigged when the location of the device of the user crosses the geographic boundary of the device of the user;
calculating an estimated arrival time of the user to the delivery location;
identifying a courier available to deliver the item at the delivery location at the estimated arrival time; and
dispatching the courier when the condition is triggered.
